(19) United States
(12) Patent Application Publication
(10) Pub. No.: US 2016/0131480 A1
(43) Pub. Date: May 12, 2016

(54) Time Multiplexed Electrodes in MEMS Inertial Sensors

(71) Applicant: Analog Devices, Inc., Norwood, MA (US)

(72) Inventors: Jeffrey A. Gregory, Malden, MA (US); Michael W. Judy, Ipswich, MA (US)

(21) Appl. No.: 14/534,467

(22) Filed: Nov. 6, 2014

(51) Int. Cl. G01C 19/56

(52) U.S. Cl. CPC G01C 19/56

(57) ABSTRACT

In certain exemplary embodiments of the present invention, rather than having two or more electrodes connected to separate bond pads for making electrical connections to separate electrical circuits to perform various electrode functions (e.g., a drive electrode for performing a drive function and a sense electrode for performing a sense function as in FIG. 1), a common electrode that can perform multiple electrode functions is electrically connected to a single bond pad, with the two electrical circuits connected to the single bond pad. The two electrical circuits are then time-multiplexed so that the electrode can be used for both electrode functions. Among other things, such an arrangement reduces the number of bond pads and therefore allows for reduction of the size of the MEMS die.

### TECHNICAL FIELD

The present invention relates to time multiplexed electrodes in MEMS devices.

### BACKGROUND ART

Micromachined Micro-Electro-Mechanical System (MEMS) devices are very small electro-mechanical devices that can be made to perform a variety of functions and are used in many products. For example, MEMS inertial sensors, such as accelerometers and gyroscopes, are often used for motion sensing in such things as cell phones, video game controllers, and automobile air bag and stability systems, to name but a few.

MEMS devices are fabricated on or from a substrate, such as a silicon or silicon-on-insulator substrate, using various types of materials and micromachining processes. Micromachining processes can include material deposition, patterning, and etching processes used to form various electrical and mechanical structures at various material layers.

Typically, a MEMS device will have various mechanical structures that need to be electrically connected to external circuitry. For example, a MEMS gyroscope typically has various drive electrodes that need to be electrically connected to a drive circuit and various sense electrodes that need to be electrically connected to a sense circuit. The external circuitry typically connects to the MEMS device through various bond pads, with each bond pad electrically connected to a corresponding mechanical structure such as a drive or sense electrode. The number of bond pads on a MEMS device can determine the minimum size of the sensor die and can limit the ability to shrink the die to reduce cost or improve functionality.

In some cases, a particular electrode can be used for multiple functions, such as, for example, driving motion of a mechanical structure and sensing motion of the mechanical structure. In such cases, circuitry for performing the various functions may be time-multiplexed to the common electrode, for example, as discussed in Gregory, Jeffrey A., Characterization, Control and Compensation of MEMS Rate and Rate-Integrating Gyroscopes (Doctoral Dissertation), University of Michigan, 2012.

### SUMMARY OF THE EMBODIMENTS

In a first embodiment of the invention there is provided a MEMS device comprising a first bond pad; a first set of electrodes comprising one or more electrodes electrically coupled to the first bond pad; a drive processor; a sense processor; and multiplexing circuitry configured to selectively couple the drive processor and the sense processor to the first bond pad, the multiplexing circuitry configured to allow the drive processor and the sense processor to share the first set of electrodes via the first bond pad in a time multiplexed manner in which the drive processor drives the first set of electrodes during a first time interval and the sense processor senses the first set of electrodes during a second time interval different from the first time interval.

In various alternative embodiments, the multiplexing circuitry may include a timing control circuit that provides control signals to the drive processor and the sense processor. The sense processor may be electrically disconnected from the first bond pad during the first time interval in response to a control signal from the timing control circuit, the sense processor may be disabled during the first time interval in response to a control signal from the timing control circuit, and/or the sense processor may be configured to ignore electrical signals received during the first time interval in response to a control signal from the timing control circuit.

In additional embodiments, the multiplexing circuitry may include a switch configured to selectively couple the drive processor to the first bond pad during the first time interval and to selectively couple the sense processor to the first bond pad during the second time interval.

In yet other embodiments, the MEMS device may further comprise a second bond pad and a second set of electrodes comprising one or more electrodes electrically coupled to the second bond pad, wherein at least one of the drive processor or the sense processor shares the first and second sets of electrodes respectively via the first and second bond pads in a time multiplexed manner.

In certain embodiments, the multiplexing circuitry may be configured to selectively couple the drive processor to the second bond pad, with the multiplexing circuitry configured to allow the drive processor to share the first and second sets of electrodes respectively via the first and second bond pads in a time multiplexed manner in which the drive processor drives the first set of electrodes during the first time interval and drives the second set of electrodes during the second time interval. The multiplexing circuitry may include a first switch configured to selectively couple the drive processor to the first bond pad during the first time interval and to selectively couple the drive processor to the second bond pad during the second time interval; and a second switch configured to selectively decouple the sense processor from the first bond pad during the first time interval and to selectively couple the sense processor to the first bond pad during the second time interval. The multiplexing circuitry may include a timing control circuit that provides control signals to the drive processor and the sense processor. The sense processor may be electrically disconnected from the first bond pad during the first time interval in response to a control signal from the timing control circuit, the sense processor may be disabled during the first time interval in response to a control signal from the timing control circuit, and/or the sense processor may be configured to ignore electrical signals received during the first time interval in response to a control signal from the timing control circuit.

In certain embodiments, the multiplexing circuitry may be configured to selectively couple the sense processor to the second bond pad, with the multiplexing circuitry configured to allow the sense processor to share the first and second sets of electrodes respectively via the first and second bond pads in a time multiplexed manner in which the sense processor senses the second set of electrodes during the first time interval and senses the first set of electrodes during the second time interval. The multiplexing circuitry may include a first switch configured to selectively couple the drive processor to the first bond pad during the first time interval and to selectively decouple the drive processor from the first bond pad during the second time interval; and a second switch configured to selectively couple the sense processor to the second bond pad during the first time interval and to selectively couple the sense processor to the second bond pad during the first time interval. The multiplexing circuitry may include a timing control circuit that provides control signals to the drive processor and the sense processor.

In certain embodiments, the multiplexing circuitry may be configured to selectively couple the drive processor and the sense processor to the second bond pad, the multiplexing circuitry configured to allow the drive processor to share the first and second sets of electrodes respectively via the first and second bond pads in a time multiplexed manner in which the drive processor drives the first set of electrodes during the first time interval and drives the second set of electrodes during the second time interval, the multiplexing circuitry further configured to allow the sense processor to share the first and second sets of electrodes respectively via the first and second bond pads in a time multiplexed manner in which the sense processor senses the second set of electrodes during the first time interval and senses the first set of electrodes during the second time interval. The multiplexing circuitry may include a first switch configured to selectively couple the drive processor to the first bond pad during the first time interval and to selectively couple the drive processor to the second bond pad during the second time interval; and a second switch configured to selectively couple the sense processor to the second bond pad during the first time interval and to selectively couple the sense processor to the first bond pad during the second time interval. The multiplexing circuitry may include a timing control circuit that provides control signals to the drive processor and the sense processor.

In any of the above embodiments, the MEMS device may be an inertial sensor, and the first and second sets of electrodes may operate on different axes.

### BRIEF DESCRIPTION OF THE DRAWINGS

The foregoing features of embodiments will be more readily understood by reference to the following detailed description, taken with reference to the accompanying drawings, in which:

FIG. 1 is a schematic diagram showing a prior art arrangement in which two electrodes are connected separately to two bond pads for making electrical connections to two electrical circuits to perform two electrode functions;

FIG. 2 is a schematic diagram showing a common electrode coupled to a single bond pad for making electrical connections to two electrical circuits, in accordance with an exemplary embodiment of the present invention;

FIG. 3 is a schematic diagram showing multiple common electrodes electrically coupled to a single bond pad and shared by the sense and drive processors, in accordance with another exemplary embodiment of the present invention;

FIG. 4 is a schematic diagram showing multiplexing circuitry in the form of a switch that is controlled by a timing control circuit to switch between one configuration in which the sense processor is electrically connected to the bond pad and another configuration in which the drive processor is electrically connected to the bond pad, in accordance with another exemplary embodiment of the present invention;

FIG. 5 is a schematic diagram showing a sense processor and a drive processor sharing a first set of electrodes via a first bond pad and the drive processor also being shared by a second set of electrodes via a second bond pad, in accordance with another exemplary embodiment of the present invention; and

FIG. 6 is a schematic diagram showing multiplexing circuitry for a configuration similar to the one shown in FIG. 5, in accordance with one exemplary embodiment.

It should be noted that the foregoing figures and the elements depicted therein are not necessarily drawn to consistent scale or to any scale. Unless the context otherwise suggests, like elements are indicated by like numerals.

### DETAILED DESCRIPTION OF SPECIFIC EMBODIMENTS

Definitions. As used in this description and the accompanying claims, the following terms shall have the meanings indicated, unless the context otherwise requires:

A “drive processor” is an electronic circuit that places an electronic signal on an electrode of a MEMS device. Depending on the type of electrode, the drive processor may place a fixed or varying electrical signal on the electrode. For example, a drive processor may place a varying electrical signal on an electrode to drive or adjust motion of a movable MEMS structure or may place a fixed electrical signal (e.g., a fixed voltage or ground) on an electrode.

A “sense processor” is an electronic circuit that senses an electronic signal on an electrode of a MEMS device. For example, a sense processor may sense motion or position of a movable MEMS structure, e.g., through electrostatic/capacitive coupling between a sense electrode and the movable MEMS structure.

A “set” contains one or more members.

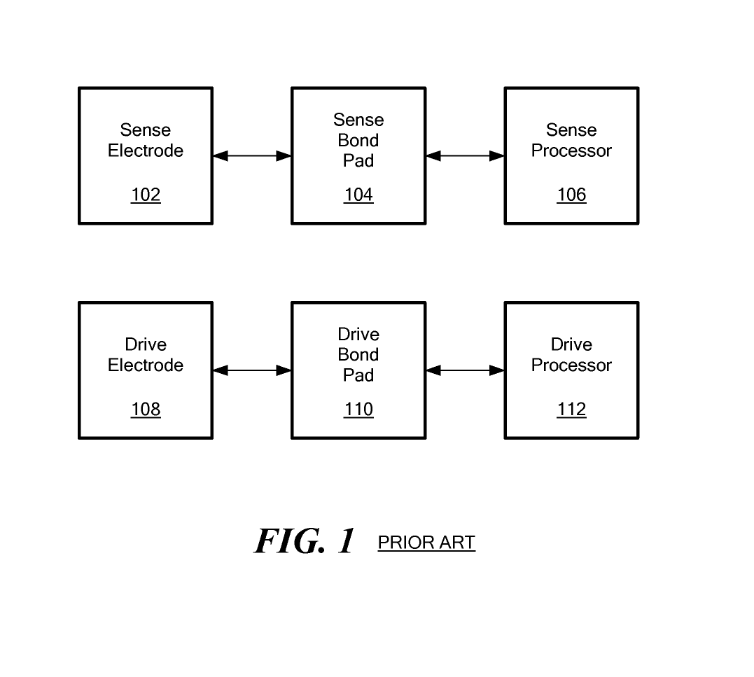

FIG. 1 is a schematic diagram showing a prior art arrangement in which two electrodes are connected separately to two bond pads for making electrical connections to two electrical circuits to perform two electrode functions. In this example, the MEMS device includes a sense electrode 102 that is electrically connected to a sense bond pad 104 allowing for an electrical connection to an external sense processor 106, and also includes a drive electrode 108 that is electrically connected to a drive bond pad 110 allowing for an electrical connection to an external drive processor 112. For the sake of the following discussion, it is assumed that the sense electrode 102 and the drive electrode 108 operate in a common axis or direction, e.g., in-plane sensing/driving or out-of-plane sensing/driving.

In certain exemplary embodiments of the present invention, rather than having two or more electrodes connected to separate bond pads for making electrical connections to separate electrical circuits to perform various electrode functions (e.g., a drive electrode for performing a drive function and a sense electrode for performing a sense function as in FIG. 1), a common electrode that can perform multiple electrode functions is electrically connected to a single bond pad, with the two electrical circuits connected to the single bond pad. The two electrical circuits are then time-multiplexed so that the electrode can be used for both electrode functions. Among other things, such an arrangement reduces the number of bond pads and therefore allows for reduction of the size of the MEMS die.

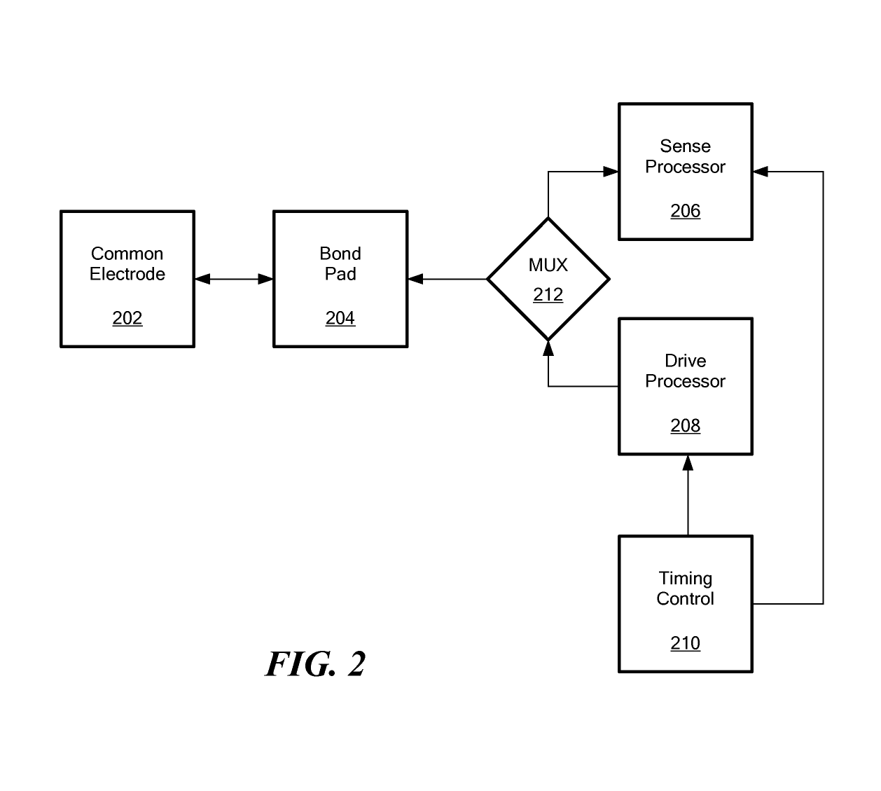

FIG. 2 is a schematic diagram showing a common electrode coupled to a single bond pad for making electrical connections to two electrical circuits, in accordance with an exemplary embodiment of the present invention. Here, common electrode 202 is electrically coupled to single bond pad 204 which in turn is coupled to a sense processor 206 and a drive processor 208 via multiplexing (mux) circuitry 212. Timing control circuit 210 allows the sense processor 206 and the drive processor 208 to share the common electrode 202 through time-multiplexing. Specifically, timing control circuit 210 controls the multiplexing circuitry 212 to electrically connect the sense processor 206 to the bond pad 204 at certain time intervals to allow the sense processor 206 to sense electrical signals on the common electrode 202 and to electrically connect the drive processor 208 to the bond pad 204 at other time intervals to allow the drive processor 208 to provide electrical signals to the common electrode 202. The timing control circuit 210 additionally may be configured to the sense processor 206 and the drive processor 208 so that the drive processor and the sense processor can be made aware of the times when they are connected to the electrode such that, for example, the drive processor can stop during the sensing cycle, and the sense processor can ignore any drive signals that may feed-through during the drive cycle, e.g., by disabling the sense processor 206 or enabling a filter that blocks drive signals from being sensed by the sense processor 206.

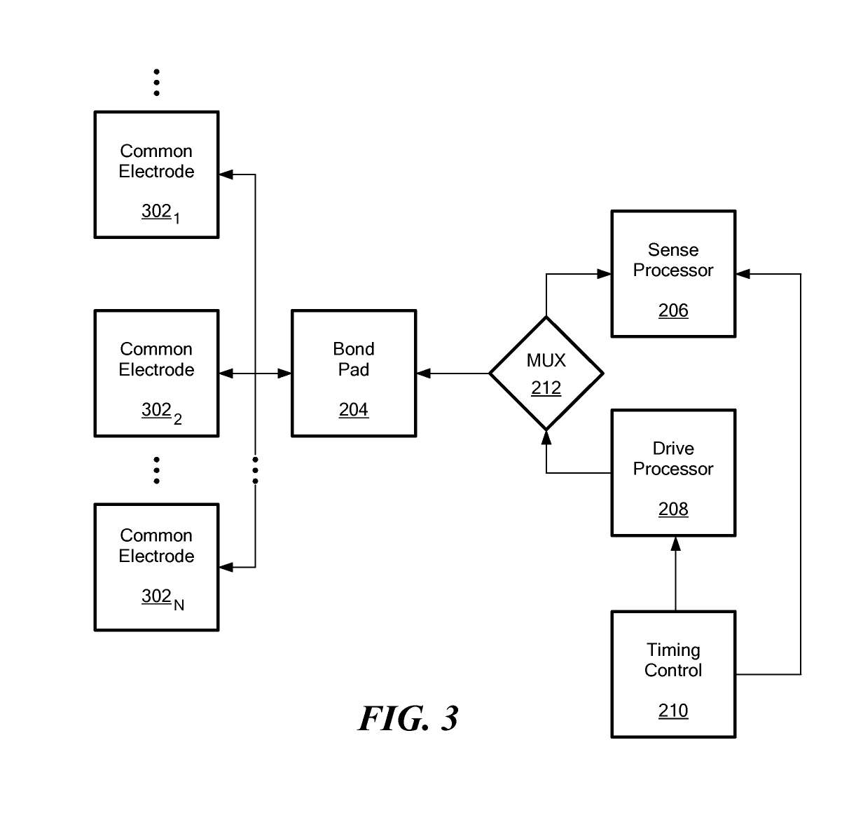

It should be noted that multiple common electrodes 302₁-302_{N} may be electrically coupled to the single bond pad 204 and shared by the sense processor 206 and the drive processor 208, as shown schematically in FIG. 3.

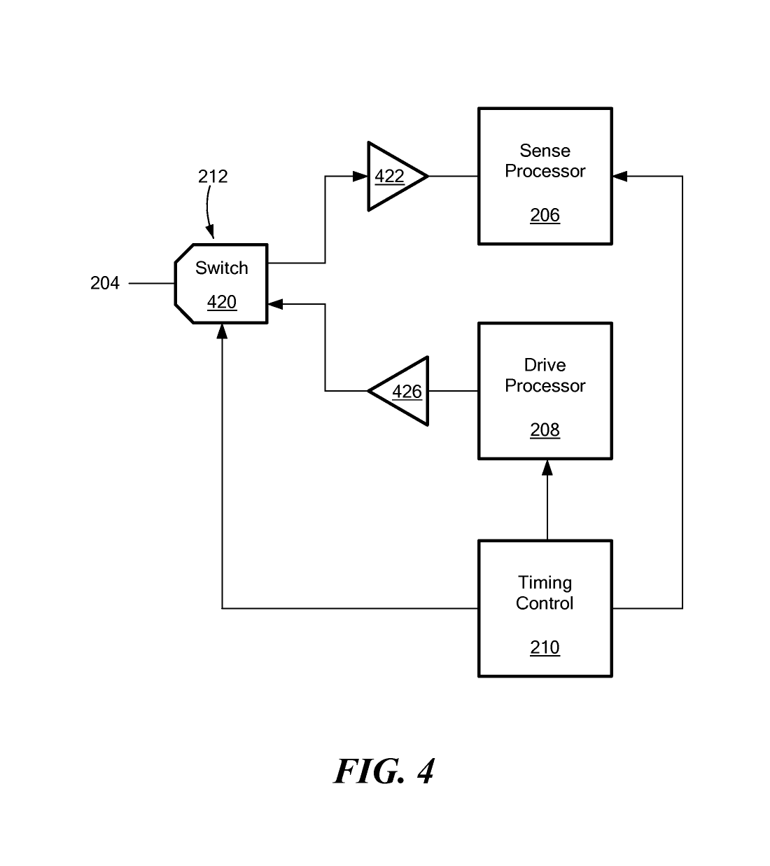

FIG. 4 is a schematic diagram showing multiplexing circuitry 212 in the form of a switch 420 that is controlled by the timing control circuit 210 to switch between one configuration in which the sense processor 206 is electrically connected to the bond pad 204 and another configuration in which the drive processor 208 is electrically connected to the bond pad 204. As discussed above, the timing control circuit 210 controls the switch 420 and also provides signals to the sense processor 206 and the drive processor 208 so that the drive processor and the sense processor can be made aware of the times when they are connected to the electrode(s). Also shown in FIG. 4 is an amplifier 422 for providing amplified signals from the electrode(s) and bond pad 204 to the sense processor 206 and an amplifier 426 for providing amplified signals from the drive processor 208 to the bond pad 204 and electrode(s).

It also should be noted that a processor may be shared between multiple electrically-separated sets of electrodes, where a set of electrodes may contain one or more electrodes coupled to a single bond pad. For example, a drive processor may drive one set of electrodes at certain time intervals and drive another set of electrodes at other time intervals. Similarly, a sense processor may sense one set of electrodes at certain time intervals and sense another set of electrodes at other time intervals. Where two sets of electrodes are shared by a sense processor and a drive processor, the circuitry may be configured so that the sense processor is sensing one set of electrodes while the drive processor is driving the other set of electrodes and vice versa.

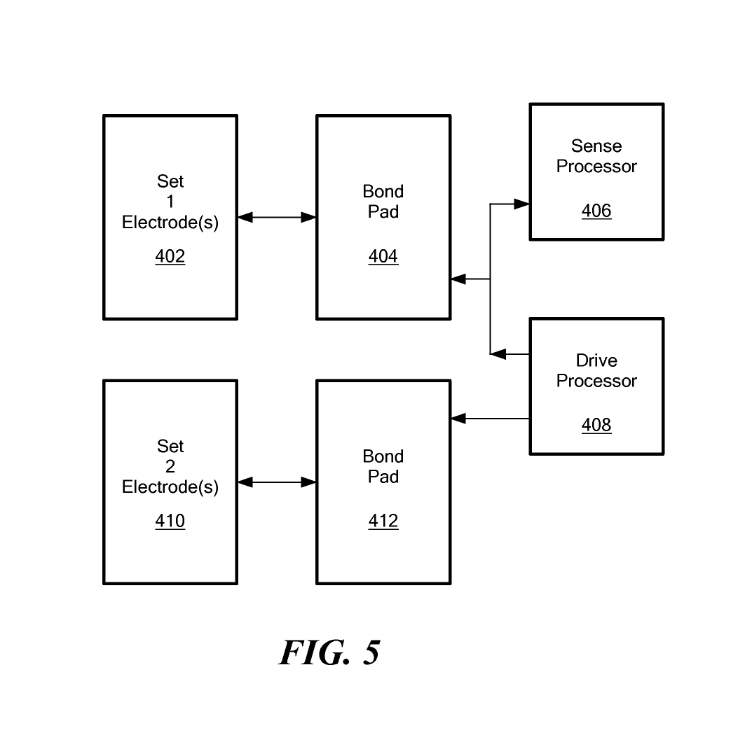

FIG. 5 is a schematic diagram showing a sense processor 406 and a drive processor 408 sharing a first set of electrodes 402 via a first bond pad 404 and the drive processor 408 also being shared by a second set of electrodes 410 via a second bond pad 412. Multiplexing circuitry (not explicitly shown) allows the sense processor 406 and the drive processor 408 to share the first set of electrodes 402 and for the drive processor 408 to share the first and second sets of electrodes 402 and 410. Thus, for example, the drive processor 408 may drive the second set of electrodes 410 during certain time intervals when the sense processor 406 is sensing the first set of electrodes 402 and may drive the first set of electrodes 402 during other time intervals.

In a MEMS sensor such as a MEMS gyroscope having a resonator mass that is caused to resonator in-plane with Coriolis sensing out-of-plane, the first and second sets of electrodes 402 and 410 may perform different functions in different sensor axes. For example, the first set of electrodes 402 may operate in an out-of-plane Coriolis axis and may be used to alternate between sensing out-of-plane motion of the resonator mass caused by Coriolis acceleration and providing an out-of-plane force to the resonator mass such as for mode matching or error cancellation, while the second set of electrodes 410 may operate in an in-plane resonator axis orthogonal to the Coriolis axis and may be used to drive resonance of the resonator mass.

Two different multiplexing schemes for an exemplary MEMS gyroscope are to multiplex much faster (e.g., at least 2× faster) than the oscillation frequency of the gyroscope and to multiplex at a rate that is higher than the bandwidth of the gyroscope but much lower than the oscillation frequency. The first method places stringent requirements on the multiplexing circuit that would significantly increase the power and complexity of the circuit but does not reduce the bandwidth or inherently increase the noise. The second method does not have stringent requirements but also does not reduce the bandwidth of the gyroscope, and the noise inside the bandwidth of the gyroscope is not increase although the maximum possible over-sampling ratio is reduced.

It should be noted that, among other things, multiplexing one processor among multiple sets of electrodes can reduce the power consumption of the MEMS device and can reduce the size of the MEMS device if the circuitry is included in the MEMS device itself.

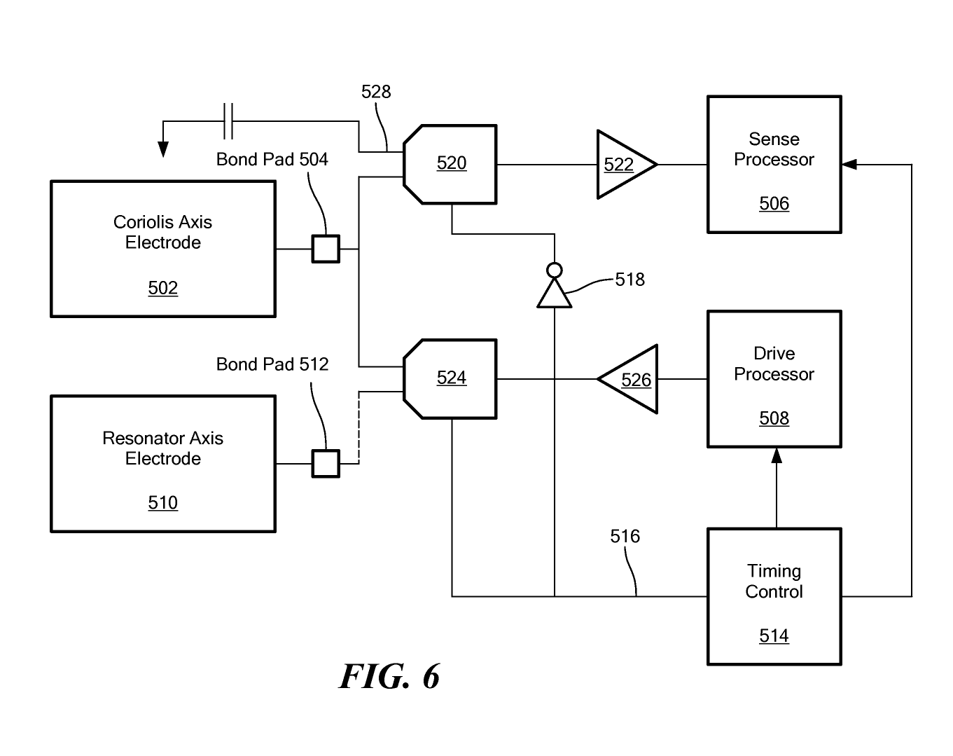

FIG. 6 is a schematic diagram showing multiplexing circuitry for a configuration similar to the one shown in FIG. 5, in accordance with one exemplary embodiment. Here, a sense processor 506 and a drive processor 508 are electrically coupled to a Coriolis axis electrode 502 via a first bond pad 504, and the drive processor 508 is also electrically coupled to a resonator axis electrode 510 via a second bond pad 512. More specifically, the sense processor 506 is electrically coupled to the bond pad 504 via a switch 520 and an amplifier 522, while the drive processor 508 is coupled to the bond pads 504 and 512 via an amplifier 526 and a switch 524, where each of the bond pads 504 and 512 is coupled to a separate output of the switch 524. A timing control circuit 514 of the multiplexing circuitry provides control signals to the sense processor 506, the drive processor 508, the switch 520 (via output 516 and inverter 518), and the switch 524 (via output 516). The timing control circuit 514 may be configured to alternate between two operational modes. In a first operational mode, the output signal 516 from timing control circuit 516 is in a first state that causes the switch 524 to route the drive signal from drive processor 508 and amplifier 526 to the bond pad 504 while the switch 520 routes a ground signal to amplifier 522 and sense processor 506. During this first operational mode, the timing control circuit 514 sends control signals to the sense processor 506 and the drive processor 508 to indicate this first operational mode, where the drive processor 508 is configured to send an appropriate drive signal to the Coriolis axis electrode 502 and the sense processor 506 may be configured to effectively ignore the input signal received from the amplifier 522. In a second operational mode, the output signal 516 from timing control circuit 516 is in a second state that causes the switch 524 to route the drive signal from drive processor 508 and amplifier 526 to the bond pad 512 while the switch 520 routes the signal from bond pad 504 to amplifier 522 and sense processor 506. During this second operational mode, the timing control circuit 514 sends control signals to the sense processor 506 and the drive processor 508 to indicate this second operational mode, where the drive processor 508 is configured to send an appropriate drive signal to the resonator axis electrode 510 and the sense processor 506 is configured to sense the Coriolis axis electrode. It should be noted that the drive signals provided by the drive processor 508 are typically different during the two operational modes, as the different electrodes are typically used for different functions that require different signals. Thus, the drive processor 508 may be enabled while switching between two drive modes; the sense processor 506 may be enabled while switching between two sense modes or may be alternately enabled and disabled, e.g., to conserve power.

It should be noted that the multiplexing circuitry shown in FIG. 5 may be modified to allow the sense processor 506 to sense the resonator axis electrode 510 while the drive generator 508 is driving the Coriolis axis electrode 502, e.g., by connecting the input 528 of the switch 520 to the bond pad 512 rather than to ground. Alternatively, the multiplexing circuitry shown in FIG. 5 may be modified to allow the sense processor 506 to sense a third electrode, e.g., by connecting the input 528 of the switch 520 to the third electrode rather than to ground. It should be noted that a processor may be shared by three or more electrodes, e.g., by using switching having three or more inputs/outputs or using multiple tiers of interconnected switches to increase the effective number of inputs/outputs.

It also should be noted that the processors and multiplexing circuitry may be external to the MEMS device and may be provided separately from the MEMS device.

It should be noted that arrows may be used in drawings to represent communication, transfer, or other activity involving two or more entities. Double-ended arrows generally indicate that activity may occur in both directions (e.g., a command/request in one direction with a corresponding reply back in the other direction, or peer-to-peer communications initiated by either entity), although in some situations, activity may not necessarily occur in both directions. Single-ended arrows generally indicate activity exclusively or predominantly in one direction, although it should be noted that, in certain situations, such directional activity actually may involve activities in both directions (e.g., a message from a sender to a receiver and an acknowledgement back from the receiver to the sender, or establishment of a connection prior to a transfer and termination of the connection following the transfer). Thus, the type of arrow used in a particular drawing to represent a particular activity is exemplary and should not be seen as limiting.

Certain aspects of the present invention, and any circuitry in particular, may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. Computer program logic implementing some or all of the described functionality typically would be implemented as a set of computer program instructions that is converted into a computer executable form, stored as such in a computer readable medium, and executed by a microprocessor under the control of an operating system. Hardware-based logic implementing some or all of the described functionality may be implemented using one or more appropriately configured FPGAs.

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some embodiments of the invention may be implemented as a combination of both software (e.g., a computer program product) and hardware. Still other embodiments of the invention are implemented as entirely hardware, or entirely software.

Importantly, it should be noted that embodiments of the present invention may employ conventional components such as conventional computers (e.g., off-the-shelf PCs, mainframes, microprocessors), conventional programmable logic devices (e.g., off-the shelf FPGAs or PLDs), or conventional hardware components (e.g., off-the-shelf ASICs or discrete hardware components) which, when programmed or configured to perform the non-conventional methods described herein, produce non-conventional devices or systems. Thus, there is nothing conventional about the inventions described herein because even when embodiments are implemented using conventional components, the resulting devices and systems (e.g., the drive processors, sense processors, and multiplexing circuitry described herein) are necessarily non-conventional because, absent special programming or configuration, the conventional components do not inherently perform the described non-conventional methods.

The present invention may be embodied in other specific forms without departing from the true scope of the invention, and numerous variations and modifications will be apparent to those skilled in the art based on the teachings herein. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. A MEMS device comprising:
a first bond pad;
a first set of electrodes comprising one or more electrodes electrically coupled to the first bond pad;
a drive processor;
a sense processor; and
multiplexing circuitry configured to selectively couple the drive processor and the sense processor to the first bond pad, the multiplexing circuitry configured to allow the drive processor and the sense processor to share the first set of electrodes via the first bond pad in a time multiplexed manner in which the drive processor drives the first set of electrodes during a first time interval and the sense processor senses the first set of electrodes during a second time interval different from the first time interval.

2. A MEMS device according to claim 1, wherein the multiplexing circuitry includes a timing control circuit that provides control signals to the drive processor and the sense processor.

3. A MEMS device according to claim 2, wherein the sense processor is electrically disconnected from the first bond pad during the first time interval in response to a control signal from the timing control circuit.

4. A MEMS device according to claim 2, wherein the sense processor is disabled during the first time interval in response to a control signal from the timing control circuit.

5. A MEMS device according to claim 2, wherein the sense processor is configured to ignore electrical signals received during the first time interval in response to a control signal from the timing control circuit.

6. A MEMS device according to claim 1, wherein the multiplexing circuitry comprises a switch configured to selectively couple the drive processor to the first bond pad during the first time interval and to selectively couple the sense processor to the first bond pad during the second time interval.

7. A MEMS device according to claim 1, further comprising:
a second bond pad; and
a second set of electrodes comprising one or more electrodes electrically coupled to the second bond pad, wherein at least one of the drive processor or the sense processor shares the first and second sets of electrodes respectively via the first and second bond pads in a time multiplexed manner.

8. A MEMS device according to claim 7, wherein the multiplexing circuitry is configured to selectively couple the drive processor to the second bond pad, the multiplexing circuitry configured to allow the drive processor to share the first and second sets of electrodes respectively via the first and second bond pads in a time multiplexed manner in which the drive processor drives the first set of electrodes during the first time interval and drives the second set of electrodes during the second time interval.

9. A MEMS device according to claim 8, wherein the multiplexing circuitry comprises:
a first switch configured to selectively couple the drive processor to the first bond pad during the first time interval and to selectively couple the drive processor to the second bond pad during the second time interval; and
a second switch configured to selectively decouple the sense processor from the first bond pad during the first time interval and to selectively couple the sense processor to the first bond pad during the second time interval.

10. A MEMS device according to claim 8, wherein the multiplexing circuitry includes a timing control circuit that provides control signals to the drive processor and the sense processor.

11. A MEMS device according to claim 10, wherein the sense processor is electrically disconnected from the first bond pad during the first time interval in response to a control signal from the timing control circuit.

12. A MEMS device according to claim 10, wherein the sense processor is disabled during the first time interval in response to a control signal from the timing control circuit.

13. A MEMS device according to claim 10, wherein the sense processor is configured to ignore electrical signals received during the first time interval in response to a control signal from the timing control circuit.

14. A MEMS device according to claim 7, wherein the multiplexing circuitry is configured to selectively couple the sense processor to the second bond pad, the multiplexing circuitry configured to allow the sense processor to share the first and second sets of electrodes respectively via the first and second bond pads in a time multiplexed manner in which the sense processor senses the second set of electrodes during the first time interval and senses the first set of electrodes during the second time interval.

15. A MEMS device according to claim 14, wherein the multiplexing circuitry comprises:
a first switch configured to selectively couple the drive processor to the first bond pad during the first time interval and to selectively decouple the drive processor from the first bond pad during the second time interval; and
a second switch configured to selectively couple the sense processor to the second bond pad during the first time interval and to selectively couple the sense processor to the second bond pad during the first time interval.

16. A MEMS device according to claim 14, wherein the multiplexing circuitry includes a timing control circuit that provides control signals to the drive processor and the sense processor.

17. A MEMS device according to claim 7, wherein the multiplexing circuitry is configured to selectively couple the drive processor and the sense processor to the second bond pad, the multiplexing circuitry configured to allow the drive processor to share the first and second sets of electrodes respectively via the first and second bond pads in a time multiplexed manner in which the drive processor drives the first set of electrodes during the first time interval and drives the second set of electrodes during the second time interval, the multiplexing circuitry further configured to allow the sense processor to share the first and second sets of electrodes respectively via the first and second bond pads in a time multiplexed manner in which the sense processor senses the second set of electrodes during the first time interval and senses the first set of electrodes during the second time interval.

18. A MEMS device according to claim 17, wherein the multiplexing circuitry comprises:
a first switch configured to selectively couple the drive processor to the first bond pad during the first time interval and to selectively couple the drive processor to the second bond pad during the second time interval; and
a second switch configured to selectively couple the sense processor to the second bond pad during the first time interval and to selectively couple the sense processor to the first bond pad during the second time interval.

19. A MEMS device according to claim 17, wherein the multiplexing circuitry includes a timing control circuit that provides control signals to the drive processor and the sense processor.

20. A MEMS device according to claim 7, wherein the MEMS device is an inertial sensor, and wherein the first and second sets of electrodes operate on different axes.
